(19) United States
(12) Patent Application Publication
(10) Pub. No.: US 2008/0174522 A1
(43) Pub. Date: Jul. 24, 2008

(54) PLASMA DISPLAY DEVICE AND DRIVING METHOD THEREOF

(75) Inventors: Byunggwon CHO, Yongin-si (KR); Jungsoo An, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 12/014,891

(22) Filed: Jan. 16, 2008

(30) Foreign Application Priority Data
Jan. 17, 2007 (KR) 2007-5432

(51) Int. Cl. G09G 3/28

(52) U.S. Cl. 345/60

(57) ABSTRACT

A plasma display device and a driving method thereof prevent a dark image retention by controlling a number of pulses applied in a reset period of a current frame compared to the number of pulses applied in a reset period of a previous frame. The driving method includes applying a first number of reset pulses to a scan electrode of the plasma display device in the reset period of the current frame and a second number of the reset pulses to the scan electrode in the reset period of the previous frame such that the first number of reset pulses applied in the reset period of the current frame is larger the second number of reset pulses applied in the reset period of the previous frame if the dark image is determined to be retained.

### CROSS-REFERENCE TO RELATED APPLICATIONS

This application claims the benefit of Korean Patent Application No. 2007-5432 filed on Jan. 17, 2007 in the Korean Intellectual Property Office (KIPO), the disclosure of which is incorporated herein by reference.

### BACKGROUND OF THE INVENTION

1. Field of the Invention

Aspects of the present invention relate to a plasma display device, and more particularly, to a plasma display device and a driving method thereof that can prevent dark image retention by changing the number of main reset pulses.

2. Description of the Related Art

A plasma display device is a flat display device that displays characters or images through the excitation of a phosphor by plasma generated in a gas discharge. A plurality of row electrodes and column electrodes are formed in a display panel of the plasma display device. A plurality of discharge cells are formed in an area in which a row electrode and column electrode intersect. A gray scale of the image is displayed by adjusting a discharge state of the discharge cells.

In a related art plasma display device, a discharge occurs in one frame period. If a previous screen displayed in a previous frame is continued for a time and then the plasma display device displays a present screen in a current frame, a retained image from the previous screen is generated on the current screen.

Referring to FIG. 1, after a predetermined peak white is displayed for a predetermined time on a whole screen displaying black, if the whole screen is displayed with a full black, then the retained image of the previous screen temporarily remains on the current screen. This retained image is called a dark image retention.

When a screen displayed with a peak white (i.e., a screen having a small load and a maximum number of pulses) is turned over the full black screen (i.e. a screen having a smaller load than the screen displayed with peak white), the dark image retention is generated as it takes time that the peak white luminance becomes the same as the full black luminance. In other words, the retained image of the previous screen is generated when the full black is displayed until wall charges of a discharged cell on the previous screen are completely removed.

However, if the time of the dark image retention is increased because it takes a long time to enable the peak white luminance to be the same as the full black luminance, then a user easily recognizes the dark image retention. Accordingly, a display quality of the plasma display panel is decreased.

### SUMMARY OF THE INVENTION

Aspects of the present invention provide a plasma display device and a driving method thereof that can prevent dark image retention by changing the number of main reset pulses.

According to an aspect of the present invention, a plasma display panel includes: a plurality of address electrodes, a plurality of sustain electrodes, and a plurality of scan electrodes; a scan electrode driver connected to the plasma display panel to apply a number of reset pulses to a scan electrode of the plurality of the scan electrodes in a reset period; and a controller connected to the scan electrode driver to control a first number of reset pulses applied to the scan electrode in a reset period of a current frame and a second number of reset pulses applied to the scan electrode in a reset period of a previous frame, wherein the first number of reset pulses and the second number of reset pulses are different if the previous frame having a first screen load factor includes a still image, the still image being continuously sustained for a duration time greater than a predetermined time, and the current frame having a second screen load factor includes an image different from the still image, and the second screen load factor is less than the first screen load factor.

According to an aspect of the present invention, the controller may include: a frame memory to store image signals by each frame; a still image determiner to compare the image signals that are applied to the previous and the current frames, and to determine whether the current frame includes a still image; a timer to determine a duration time of the determined still image and to compare the duration time and the predetermined time; a load factor calculator to calculate the first and second screen load factors; a dark image retention determiner to compare the first screen load factor to the second screen load factor and to determine whether the dark image is retained in the current frame; a reset pulse number controller to control the first number of reset pulses applied to the scan electrode in the reset period of the current frame according to the result of the dark image retention determiner.

According to an aspect of the present invention, the duration time may be from about 25 to 35 seconds.

According to an aspect of the present invention, the reset pulse number controller determines the first number of reset pulses applied in the reset period of the current frame and the second number of reset pulses applied for the reset period of the previous frame when the first screen load factor is 0˜50% and the second screen load factor is less than the first screen load factor.

According to an aspect of the present invention, the first and second number of reset pulses applied for the reset period of the current and previous frames are the same when the first screen load factor is 51˜100% and the second screen load factor is less than the first screen load factor or when the image signal displayed in the previous frame is determined to a moving image.

According to an aspect of the present invention, the first number may be 2, and the second number may be 1.

According to an aspect of the present invention, the reset pulse may be a main reset pulse including a rising ramp pulse and a falling ramp pulse applied to the scan electrode in the reset period of the previous frame or the current frame.

According to an aspect of the present invention, the plasma display device may further include: an address electrode driver connected between the plasma display panel and the controller to apply a display data signal to the address electrode according to the control of the controller; and a sustain electrode driver connected between the plasma display panel and the controller to apply a sustain pulse to the sustain electrode according to the control of the controller.

According to an aspect of the present invention, a driving method of a plasma display device having a plurality of scan electrodes, sustain electrodes, and address electrodes, the method including: dividing one frame into a plurality of subfields having a number of emissions; dividing each subfield into a reset period, address period, and sustain period; displaying in a previous frame a still image that is continuously sustained for a duration time greater than a predetermined time; displaying an image of a current frame having a second screen load factor, the image of the current frame being different from the still image; determining in a controller whether the second screen load factor is less than the first screen load factor; and controlling a first number of reset pulses applied to a scan electrode of the plurality of scan electrodes in the reset period of the current frame and a second number of reset pulses applied to the scan electrode of the plurality of scan electrodes in the reset period of the previous frame wherein the first number and second number are different if the second screen load factor is less than the first screen load factor.

According to an aspect of the present invention, the displaying the still image of the previous frame may include: storing image signals by each frame in a frame memory; comparing image signal of the previous and current frames in the still image determiner connected to the frame memory to determining whether the current frame includes the still image; and determining the duration time of the determined still image in a timer that is connected to the still image determiner.

According to an aspect of the present invention, the duration time may be from 25 seconds to 35 seconds.

According to an aspect of the present invention, the determining in the controller whether the second screen load factor is less than the first screen load factor may include: calculating the first screen load factor and the second screen load factor in a load factor calculator that is connected to the still image determiner; and comparing the first screen load factor to the second screen load factor in a dark image retention determiner that is connected with the load factor calculator to determine whether the dark image is retained in the current frame.

According to an aspect of the present invention, the comparing of the first screen load factor to the second screen load factor may include determining that the dark image is retained in the current frame if the first screen load factor is 0˜50% and the second screen load factor is less than the first screen load factor.

According to an aspect of the present invention, the first number of the reset pulses applied in the reset period of the current frame is larger than the second number of the reset pulses applied in the reset period of the previous frame if the dark image is retained in the current frame.

According to an aspect of the present invention, the driving method may further include the first and second numbers of the reset pulses are equal if the first screen load factor is 51˜100% and the second screen load factor is less than the first screen load factor or if the image signal displayed in the previous frame is a moving image.

According to an aspect of the present invention, the first number may be 2, and the second number may be 1.

According to an aspect of the present invention, the driving method of the plasma display device may further comprise applying the first number of reset pulses to the scan electrode in the reset period of the current frame and the second number of the reset pulses to the scan electrode in the reset period of the previous frame.

According to an aspect of the present invention, the reset pulse may be a main reset pulse including a rising ramp pulse and falling ramp pulse applied to the scan electrode for the reset period of the previous or the current frame.

According to an aspect of the present invention, the driving method of the plasma display device may further include: applying a display data signal to the address electrode from an address electrode driver that is connected to the plasma display panel; and applying a sustain pulse to the sustain electrode from a sustain electrode driver that is connected to the plasma display panel.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a drawing illustrating an example of a previous frame screen and a current frame screen in which a dark image is retained;

FIG. 2 is a block diagram illustrating a plasma display device according to one exemplary embodiment of the present invention;

FIG. 3 is a block diagram illustrating an inside of a controller of FIG. 2;

FIG. 4 is a table illustrating determining an image retention according to a load factor of the previous frame and current frame;

FIG. 5A is a graph illustrating the time that the luminance of a discharge cell of the image retention part generated on the screen of the current frame returns to the original luminance of the discharge cell of the current frame after generation of the dark image retention to which one or two main reset pulses are applied to a scan electrode respectively for a reset period of the current frame in which the dark image retention is detected;

FIG. 5B is a graph illustrating the luminance variation when two reset pulses are applied to the scan electrode in the reset period of the current frame in which the dark image retention is detected and one reset pulse is applied to the scan electrode for the reset period of the current frame in which the dark image retention is not detected;

FIG. 6 is a waveform diagram illustrating an example of a driving waveform according to a driving method of the plasma display device of FIG. 2;

FIG. 7 is a waveform diagram illustrating a driving waveform applied for the reset period in the frame of the screen on which the dark image retention is generated; and

FIG. 8 is flow chart illustrating processes of controlling the number of the main reset pulses that are applied to the scan electrode for reset period by a controller.

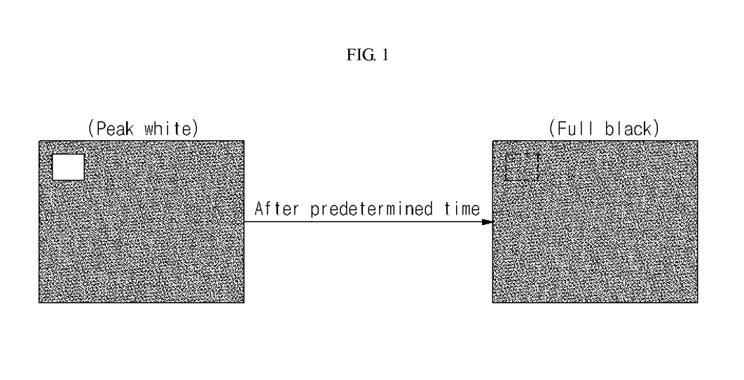

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain aspects of the present invention by referring to the figures.

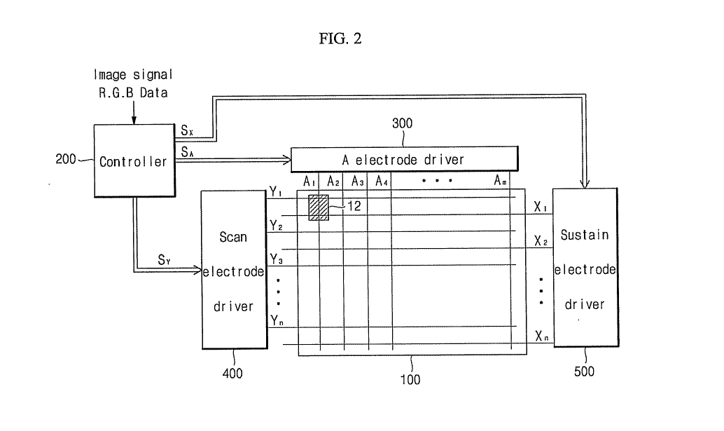

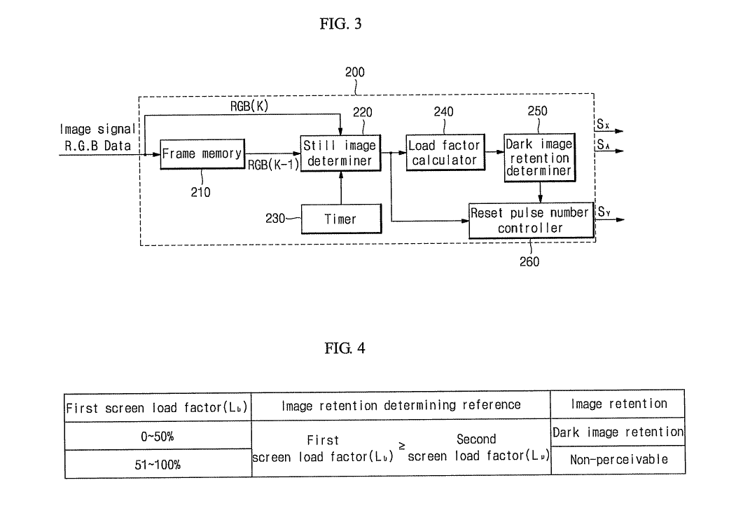

FIG. 2 is a block diagram illustrating a plasma display device according to an exemplary embodiment of the present invention, and FIG. 3 is a block diagram illustrating elements of a controller of FIG. 2. Referring to FIG. 2, the plasma display device includes a plasma display panel 100, a controller 200, an address electrode driver 300, a scan electrode driver 400, and a sustain electrode driver 500.

The plasma display panel 100 includes a plurality of address electrodes (hereinafter “A electrodes”) (A₁˜Aₘ) extending in a column direction, a plurality of sustain electrodes (hereinafter “X electrodes”) (X₁˜Xₙ) extending in a row direction, and a plurality of scan electrodes (hereinafter “Y electrodes”) (Y₁˜Yₙ) extending in the row direction. The X electrodes (X₁˜Xₙ) and the Y electrodes (Y₁˜Yₙ) extend in the row direction as pairs. Generally, each of the X electrodes (X₁˜Xₙ) form a pair with a corresponding Y electrodes (Y₁˜Yₙ), and the X electrodes (X₁˜Xₙ) and Y (Y₁˜Yₙ) electrodes perform display operations to display an image in a sustain period. The X electrodes (X₁˜Xₙ) and the Y electrodes (Y₁˜Yₙ) are arranged to intersect with the A electrodes (A₁˜Aₘ). In such case, a discharge space is formed in an area about the intersection of the A electrodes (A₁˜Aₘ), the X electrodes (X₁˜Xₙ), and the Y electrodes (Y₁˜Yₙ). The A electrodes (A₁˜Aₘ), the X electrodes (X₁˜Xₙ), and the Y electrodes (Y₁˜Yₙ) intersect in the area, which is further defined by barrier ribs (not shown) to form a discharge cell 12.

The above-described structure of the plasma display panel 100 is only one example but not limited thereto. A driving waveform according to aspects of the present invention may be applied to a plasma display panel having a different structure.

The controller 200 receives an image signal (including RGB data) and a sync signal, and outputs an address electrode driving control signal (S_{A}), a scan electrode driving control signal (S_{Y}), and a sustain electrode driving control signal (S_{X}). The controller 200 is driven by dividing one frame into a plurality of sub-fields, each subfield including a reset period, an address period, and a sustain period.

The controller 200 determines whether the image signal is a still image according to the received image signal (including RGB data). If the image signal is determined to be a still image, the controller 200 temporarily increases a main reset pulse applied to the Y electrodes (Y₁˜Yₙ) for the reset period of the frame in which a dark image is retained and reduces the main reset pulse applied to the Y electrodes (Y₁˜Yₙ) for the reset period of other frames. Herein, the main reset pulse includes a rising ramp pulse and a falling ramp pulse applied to the Y electrodes (Y₁˜Yₙ) in the reset period.

An operation of the controller 200 to control the number of main reset pulses will be explained in detail with reference to FIG. 2. The address electrode driver 300 processes the address electrode driving control signal (S_{A}) of the electrode driving control signals (S_{A}, S_{Y}, S_{X}) to generate a display data signal and applies the generated display data signal to the A electrodes (A₁˜Aₘ). The scan electrode driver 400 processes the scan electrode driving control signal (S_{Y}) of the electrode driving control signals (S_{A}, S_{Y}, S_{X}) from the controller 200 to generate a scan pulse and applies the generated scan pulse to the Y electrodes (Y₁˜Yₙ). The sustain electrode driver 500 processes the sustain electrode driving control signal (S_{X}) of the electrode driving control signals (S_{A}, S_{Y}, S_{X}) from the controller 200 to generate a sustain pulse and then applies the generated sustain pulse to the X electrodes (X₁˜Xₙ).

FIG. 3 is a block diagram illustrating elements of the controller of FIG. 2. Referring to FIG. 3, the controller 200 includes a frame memory 210, a still image determiner 220, a timer 230, a load factor calculator 240, a dark image retention determiner 250, and a reset pulse number controller 260.

The frame memory 210 receives and stores an image signal (RGB data) according to frames. The still image determiner 220 is connected to the frame memory 210 and compares a first image signal (RGB (k−1)) of a predetermined frame stored in the frame memory 210 to a second image signal (RGB (k)) of a frame after the predetermined frame (i.e., by comparing image signals of a continued frame). The still image determiner 220 determines whether the first and second image signals (RGB (k−1) and (RGB (k)) are a still image according whether the first and second image signals (RGB (k−1) and (RGB (k)) are the same. Herein, if the image signals of the continued frame are different, the still image determiner 220 determines the first and second image signals (RGB (k−1) and (RGB (k)) as a moving image.

The timer 230 is connected to the still image determiner 220 to check a duration time and determines whether the determined duration time of the still image is greater than a predetermined time (e.g., above 25 to 35 seconds). Herein, the predetermined time is a time sufficient to generate an image retention, i.e., a time sufficient for an image to be retained in a following frame. Because the duration time in which an image may be retained may change according to the kind of the plasma display panel, the duration time is decided by experiment. If the moving image is again input after the still image state, the timer 230 is reset and restarted.

The load factor calculator 240 is connected to the still image determiner 220 and calculates a screen load factor (hereinafter a “first screen load factor”) of the previous frame in which the image data of the still image is maintained for greater than the predetermined time (e.g., 25 to 30 seconds), and the load factor calculator 240 calculates a screen load factor (hereinafter “second screen load factor”) of the current frame in which an image data different from the image data of the previous frame is input. Herein, the term “the screen load factor” means a ratio of an area of discharge cells discharged in the sustain period to an area of all cells of the plasma display panel.

The dark image retention determiner 250 is connected to the load factor calculator 240 and compares the first screen load factor to the second screen load factor so as to determine a portion of the screen in which the dark image retention is detected. To determine the portion of the screen in which the dark image retention is detected will be explained referring to FIG. 4. FIG. 4 is a table illustrating the determination of a dark image retention according to a load factor of the previous frame and the current frame. Referring to FIG. 4, if the first screen load factor (L_{b}) that is calculated in the load factor calculator 240 is from 0 to 50%, the dark image retention determiner 250 determines that the dark image is retained on the screen of the current frame when the second screen load factor (Lₚ) is less than the first screen load factor (L_{b}). In other words, when the previous frame having a low first screen load factor (L_{b}) (i.e., 0 to 50%) is changed into the current frame having the second screen load factor (Lₚ) that is less than the first screen load factor (L_{b}), a dark image, in which the image displayed on the screen of the previous frame temporarily remains on the screen of the current frame, is determined to be retained.

It is determined whether the dark image is retained, when the screen of the previous frame having the first screen load factor (L_{b}) of 0 to 50% is changed into the screen of the current frame having the second screen load factor (Lₚ) that is less than the first screen load factor (L_{b}). However, if the first screen load factor (L_{b}) is high (i.e., 51% to 100%), a user cannot easily recognize an image retained on the screen of the current frame because the screen of the previous frame is changed into the screen of the current frame having the second screen load factor (Lₚ) that is greater than the first screen load factor (L_{b}).

The reset pulse number controller 260 is connected to the still image determiner 220 and the dark image retention determiner 250. When the reset pulse number controller 260 receives information regarding the screen of the current frame in which a dark image retention is detected, the reset pulse number controller 260 sets the number of the main reset pulses applied to the Y electrodes (Y₁˜Yₙ) for the reset period of the current frame to m number of reset pulses (m indicates a natural number) that is larger than n number of the main reset pulses (n indicates a natural number) that is a predetermined number of main reset pulses. For example, the “n” may set to “1”, and “m” may set to “2”.

As described above, if the reset pulse number controller 260 increases the number of the main reset pulses applied to the Y electrodes (Y₁˜Yₙ) for the reset period of the current frame in which the dark image retention is detected, (i.e., the reset pulse number controller 260 increases the number of the main reset pulses to 2), wall charges of a discharge cell that retains the display image of the previous frame can be quickly erased in the reset period of the current frame. Further, by decreasing the time necessary to erase the wall charges that retain the display image of the previous frame, the time that the luminance of the discharge cell corresponding to the image retention portion of the screen of the current frame returns to an original or intended luminance of the discharge cell of the current frame is decreased. Accordingly, the dark image retention duration time, a time for which an image retention of the previous frame is retained on the screen of the current frame, is reduced. Thus, a user cannot easily recognize the dark image retention, thereby allowing the picture quality of the plasma display panel to be improved. However, when the reset pulse number controller 260 receives data regarding the screen of the current frame in which a dark image retention is not detected or receives data regarding the screen of the previous frame displaying a moving image from the still image determiner 220, the number of the main reset pulses applied to the Y electrodes (Y₁˜Yₙ) for the reset period of the current frame is set to a predetermined number of reset pulses, i.e., 1. Further, when the reset pulse number controller 260 receives data regarding the screen of the current frame in which a dark image retention is not detected or receives data regarding the screen of the previous frame displaying a moving image from the still image determiner 220, the number of the main reset pulses applied to the Y electrodes (Y₁˜Yₙ) for the reset period of the current frame may be the number of reset pulses of the previous frame, i.e., 1.

As described above, if the number of the main reset pulses applied to the Y electrode (Y₁˜Yₙ) is set to “1”, then an increase of a black luminance (black luminance indicates amount of light emitted by the reset discharge) generated in the case of continuously setting the number of the main reset pulses to “2” can be prevented. Accordingly, a decrease in the contrast ratio can be prevented. Therefore, the two main reset pulses are temporarily applied to the current frame in which the dark image retention is detected, and the one main reset pulse is applied to the others.

The reset pulse number controller 260 outputs the scan electrode driving control signal (S_{Y}) including information on the set number of the main reset pulses. Then, the scan electrode driver 400 of FIG. 2, which is connected to the reset pulse number controller 260, applies the main reset pulse to the Y electrodes (Y₁˜Yₙ) for the reset period according to the scan electrode driving control signal (S_{Y}) including data about the number of the main reset pulses.

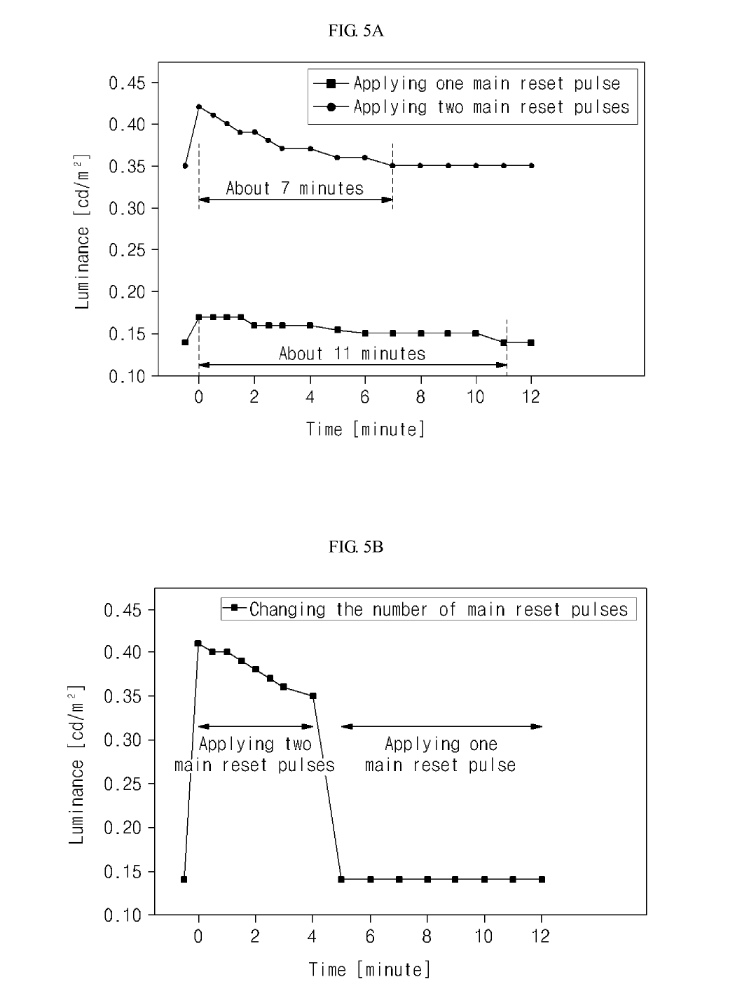

When two main reset pulses are applied to the Y electrodes (Y₁˜Yₙ) for the reset period of the current frame in which the dark image retention is detected, the reduction of the dark image retention on the current frame will be explained with reference to FIGS. 5A and 5B.

FIG. 5A is a graph illustrating the time that the luminance of the discharge cell in which the dark image is retained on the screen of the current frame returns to the original or intended luminance of the discharge cell of the current frame after generation of the dark image retention in respective cases of one and two main reset pulses applied to a Y electrode respectively for a reset period of the current frame in which the dark image retention is detected. FIG. 5B is a graph illustrating the luminance variation in a case that two reset pulses are applied to the Y electrode for the reset period of the current frame in which the dark image retention is detected and one reset pulse is applied to the Y electrode for the reset period of the current frame in which the dark image retention is not detected.

Referring to FIG. 5A, when the one reset pulse is applied to the Y electrode for the reset period of the current frame in which the dark image retention is detected, the original luminance returns after 11 minutes such that the luminance of the discharge cell of the dark image retention part generated on the screen of the current frame returns to the original luminance of the discharge cell of the current frame. In other words, the dark image retention of the previous frame is maintained on the current frame for 11 minutes. On the other hand, when two reset pulses are applied to the Y electrode in the reset period of the current frame in which the dark image retention is detected, the original luminance returns in about 7 minutes such that the luminance of the discharge cell of the dark image retention part generated on the screen of the current frame returns to the original luminance of the discharge cell of the current frame. In other words, the dark image retention of the screen of the previous frame is maintained on the current screen for only 7 minutes. That is, when the two main reset pulses are applied to the Y electrode, the duration time of the dark image retention is decreased by about 4 minutes compared to the application of only one main reset pulse. Therefore, if the number of the main reset pulses applied to the reset period of the current frame in which the dark image retention is generated is increased, the duration time of the dark image retention on the screen of the current frame is decreased, thereby allowing the image quality of the plasma display panel to be improved.

Herein, when the two reset pulses are applied to the Y electrode in the reset period of the current frame, a sudden luminance variation is generated by the increase of the black luminance. Thus, if two of the main reset pulses are continuously applied, the contrast ratio of the screen is decreased. Accordingly, as illustrated in FIG. 5B, if one reset pulse is applied to the Y electrode in the reset period of the frame in which the dark image retention is not detected, and two reset pulses are temporarily applied to the Y electrode for the reset period of the frame in which the dark image retention is detected, then the contrast ratio of the screen can be increased while decreasing the duration time of the dark image retention on the screen.

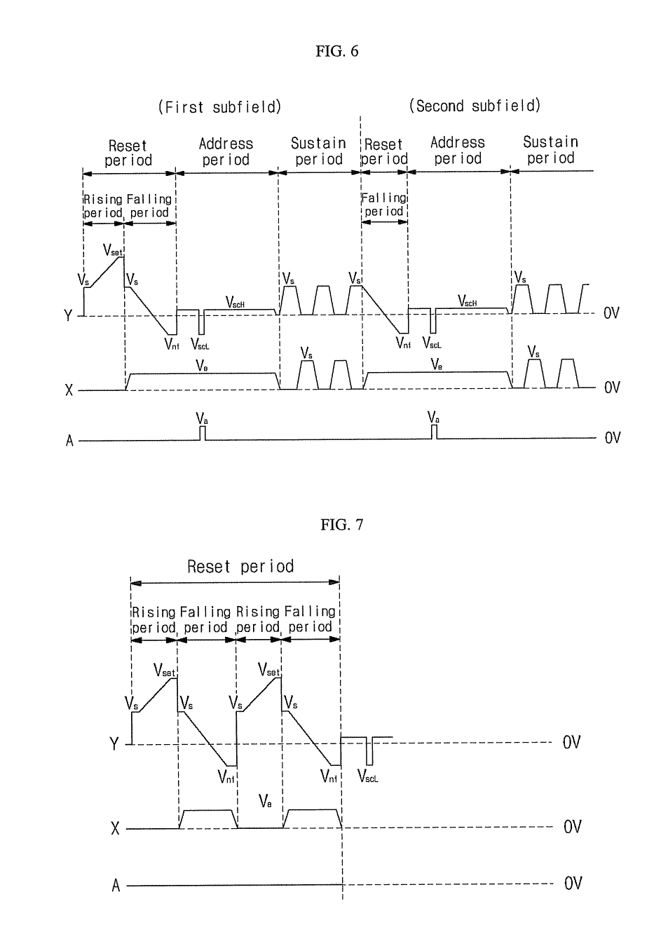

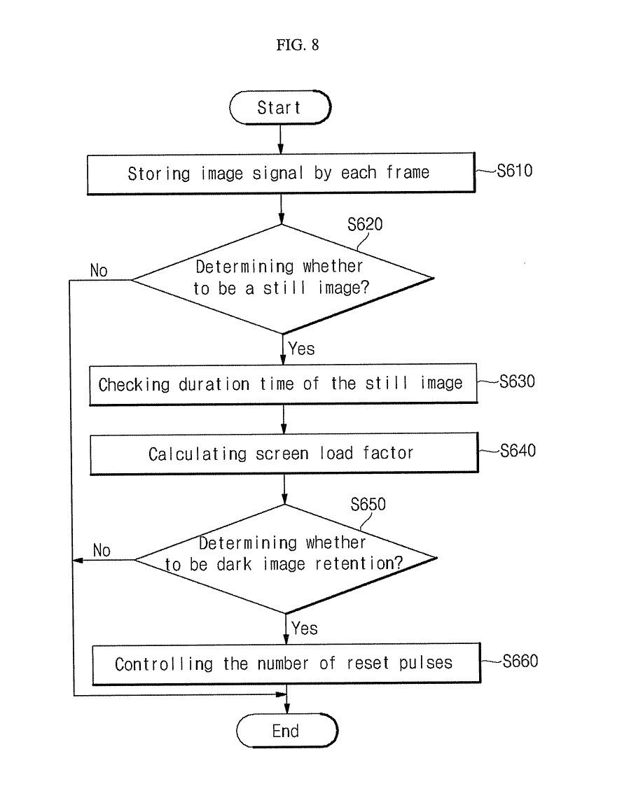

FIG. 6 is a waveform diagram illustrating one example of a driving waveform in a driving method of the plasma display device of FIG. 2. FIG. 7 is a waveform diagram illustrating a driving waveform applied in the reset period in a frame of the screen on which a dark image is retained. Referring to FIG. 6, the driving waveform of two subfields of a plurality of subfields forming one frame is shown. Hereafter, the driving waveform that is applied to the Y electrode, the X electrode, and the A electrode of one cell will be explained.

In the driving waveform for driving the plasma display device, one frame is divided into a plurality of the subfields (e.g., from 8 to 11 subfields). Each subfield includes a reset period, an address period, and a sustain period.

The reset period is a period of initializing the discharge cell. A reset pulse (hereinafter a “main reset pulse”) to erase a wall charge after stacking the wall charge in the discharge cell is applied in the reset period of a first subfield. A reset pulse (hereinafter a “sub-reset pulse”) to erase only the wall charges of the discharge cell that generates the discharge in the previous subfield by erasing wall charges without stacking wall charges in the discharge cell is applied in the reset period of the subfield following the second subfield. The address period is a period in which the discharge cell to be discharged among the discharge cells is selected, and the sustain period is a period in which the discharge cells selected in the address period are discharged.

The driving waveform of the first subfield among the plurality of subfields in one frame will be explained. First, the reset period of the first subfield is a period that applies the main reset pulse and includes a rising period and falling period. In the rising period, the rising ramp voltage, which rises gradually from a Vₛ voltage to a Vₛₑₜ voltage, is applied to the Y electrode while the X electrode is maintained at 0 volts. Then, a weak reset discharge is generated respectively between the Y electrode and the A electrode and between the Y electrode and X electrode. Accordingly, a negative (−) wall charge is formed in the Y electrode, and positive (+) wall charges are formed in the A electrode and X electrode.

In the falling period of the reset period of the first subfield, Vₑ volts are applied to the X electrode, the falling ramp voltage, which decreases gradually from a Vₛ voltage to a V_{nf} voltage, is applied to the Y electrode. Then, while the voltage of the Y electrode is reduced, the weak reset discharge is generated between the Y electrode and the X electrode and between the Y electrode and A electrode, and simultaneously the negative wall charge formed in the Y electrode and the positive wall charges formed in the A electrode and X electrode are erased. Herein, the wall charges are not completely erased, and the number of the wall charges distributed in the entire area of the discharge cell is only reduced. The Y electrode is maintained at the Vₙₜ voltage for a predetermined time (i.e., for the maintaining period) until entering the address period after the falling period.

Herein, if the generation of the dark image retention is detected from the frame, then m (e.g., m=2 in FIG. 7) reset pulses are applied to the Y electrode for the reset period of the first subfield. And then, for the reset period of the frame in which the dark image retention is generated, the wall charges of the discharge cell in which the discharge is previously generated can be rapidly erased. The time that the luminance of the discharge cell of the image retention part generated on the screen of the frame returns to the original luminance of the discharge cell of the frame is shortened by the reduced wall charge erase time. Accordingly, the dark image retention duration time that the previous image is sustained on the screen of the frame is reduced, and the user does not perceive the dark image retention, thereby allowing the picture quality of the plasma display panel to be improved.

And, in a frame in which the generation of the dark image retention is not detected, n (e.g., n=1) reset pulses are applied to the Y electrode for the reset period of the first subfield.

Next, in the address period of the first subfield, the scan pulse of a V_{scL} voltage and the address pulse of a Vₐ voltage are respectively applied to the Y electrode and A electrode to select discharge cells in which a discharge is to occur. The non-selected Y electrodes are biased to the V_{scH} voltage, which is higher than the V_{scL} voltage, and 0 volts is applied to the A electrode of discharge cells in which a discharge is to not occur. Then, the address discharge is generated by the sum of a wall voltage by the wall charge formed in the A electrode and Y electrode, and the voltage difference between the Vₐ and the V_{scL} voltage. As a result thereof, positive (+) wall charges are formed in the Y electrode and negative (−) wall charges are formed in the X electrode.

Continuously, in the sustain period of the first subfield, the sustain pulse of the Vₛ voltage is applied alternatively. Here, the voltage difference between the Y electrode and X electrode alternatively becomes the Vₛ voltage and the −Vₛ voltage by the sustain pulse, and width of the sustain pulse applied to the Y electrode and X electrode is the same. If the wall voltage is formed between the Y electrode and the X electrode by the address discharge in the previous address period, the sustain discharge is generated between the Y electrode and X electrode by the sum of the wall voltage and Vₛ voltage. Here, the process of applying the sustain pulse of the Vₛ voltage to the Y electrode and applying the Vₛ voltage to the X electrode are repeated according to a weight value, which the corresponding subfield displays.

The process by which the number of the main reset pulses are applied to the Y electrode for the reset period is controlled by the controller will be explained referring to FIG. 8 and with further reference to FIG. 3.

FIG. 8 is flow chart illustrating processes of controlling the number of the main reset pulses that are applied to the scan electrode for reset period by a controller. A driving method of the plasma display device according to an exemplary embodiment of the present invention includes displaying a still image that is sustained during a predetermined time in a previous frame having a first screen load factor; determining in a controller whether to display an image different from the still image in a current frame having a second screen load factor that is less than the first screen load factor; and controlling the number of reset pulses applied to the scan electrode Y for the reset period of the current frame differently from the number of the main reset pulses supplied to the scan electrode Y for the reset period of the previous frame when the second screen load factor is less than the first screen load factor.

Referring to FIG. 8, the displaying a still image that is sustained during a predetermined time in a previous frame having a first screen load factor includes storing the image signal by each frame (S610), determining whether the image signals are the still image (S620), and checking the duration time of the still image (S630). In S610, the frame memory 210 receives the image signal from the outside so as to store the received image signal in each frame. In S620, the still image determiner 220 connected to the frame memory 210 compares the image signals of the continued frames stored in the frame memory 210 and determines a still image according to whether the image signals of the continued frame are the same. If the image signals of the continued frame are the same, the image signals are the still image, and if the image signals of the continued frame are not the same, the image signals are a moving image. In S630, the timer 230 connected to the still image determiner 220 checks the duration time of the still image determined in the operation S620, (e.g., whether the still image is continuously sustained for 25 to 30 seconds or more). Herein, if the still image is changed into the moving image, the timer 230 is reset and restarted.

In the determining in a controller whether to display an image different from the still image in a current frame having a second screen load factor that is less than the first screen load factor, the screen load factor is calculated (S640), and the existence of a dark image retention is determined in S650. In S640, the load factor calculator 240 connected to the still image determiner 220 calculates the screen load factor of the previous frame determined to include the still image sustained for the predetermined time by the timer 230 (i.e., the first screen load factor), and the screen load factor of the current frame input having an image signal different from the previous frame (i.e., the second screen load factor). In S650, the dark image retention determiner 250 connected to the load factor calculator 240 compares the first screen load factor to the second screen load factor calculated in the load factor calculator 240 and determines a portion of the screen in which the dark image retention is detected. Accordingly, the dark image retention determiner 250 outputs information on the current frame included in the screen in which the dark image retention is detected.

In S650, as the result of the comparison of the first screen load factor and the second screen load factor, if the second screen load factor is less than the first screen load factor, the controller 200 controls the number of the main reset pulses applied to the Y electrode in the reset period of the current frame differently from the number of the main reset pulse applied to the Y electrode in the reset period of the previous frame in S660. In other words, in S660, the reset pulse number controller 260 connected to the dark image retention determiner 250 receives information about the screen of the current frame in which the dark image retention is detected from the dark image retention determiner 250. As a result thereof, the reset pulse number controller 260 sets the number of the main reset pulses applied to the Y electrode for the reset period of the current frame to m number of reset pulses that is larger than n number of the main reset pulses applied to the Y electrode in the reset period of the previous frame. For example, n may be set to 1, m may be set to 2.

On the other hand, if the reset pulse number controller 260 receives information on the screen of the current frame in which the dark image retention is not detected by the dark image retention determiner 250 or information on the screen of the previous frame for displaying the moving image from the still image determiner 220, the number of the main reset pulses applied to the Y electrode for the reset period of the current frame is set to n number of main reset pulses, e.g., 1.

Accordingly, 2 main reset pulses are temporarily applied in the current frame in which the dark image retention is detected, and 1 main reset pulse is applied to the other frames, thereby preventing the contrast ratio of the screen from falling while reducing the dark image retention.

As described above, the plasma display device and driving method thereof according to aspects of the present invention produces the following and/or other effects: first, the wall charge erase time of the discharge cell discharged on the screen of the previous frame is reduced by temporarily increasing the number of the main reset pulses for the reset period of the frame in which the dark image retention is detected, thereby decreasing the time that the image retention of the screen of the previous frame is maintained on the screen of the current frame so as to prevent the production of the dark image retention. Thus the image quality of the plasma display panel is improved

Second, the predetermined number of main reset pulses is again applied to the scan electrode for the reset period of the frame in which the dark image retention is not detected, thereby preventing the contrast ratio of the screen from being decreased when the increased number of the main reset pulses is applied continuously to the scan electrode.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A plasma display device, comprising:
a plasma display panel including a plurality of address electrodes, a plurality of sustain electrodes, and a plurality of scan electrodes;
a scan electrode driver connected to the plasma display panel to apply a number of reset pulses to a scan electrode of the plurality of the scan electrodes in a reset period; and
a controller connected to the scan electrode driver to control a first number of reset pulses applied to the scan electrode in a reset period of a current frame and a second number of reset pulses applied to the scan electrode in a reset period of a previous frame,
wherein the first number of reset pulses and the second number of reset pulses are different if the previous frame having a first screen load factor includes a still image, the still image being continuously sustained for a duration time greater than a predetermined time, and the current frame having a second screen load factor includes an image different from the still image, and the second screen load factor is less than the first screen load factor.

2. The plasma display device of claim 1, wherein the controller comprises:
a frame memory to store image signals by each frame;
a still image determiner to compare image signals that are applied to the previous and the current frames and to determine whether the current frame includes a still image;
a timer to determine the duration time of the determined still image and to compare the duration time and the predetermined time;
a load factor calculator to calculate the first screen load factor and the second screen load factor;
a dark image retention determiner to compare the first screen load factor to the second screen load factor to determine whether a dark image is retained in the current frame; and
a reset pulse number controller to control the first number of reset pulses applied to the scan electrode in the reset period of the current frame according to a result of the dark image retention determiner.

3. The plasma display device of claim 2, wherein the predetermined time is about 25 to 35 seconds.

4. The plasma display device of claim 2, wherein the reset pulse number controller determines the first number of reset pulses applied in the reset period of the current frame and the second number of reset pulses applied in the reset period of the previous frame.

5. The plasma display device of claim 4, wherein the first number is greater than the second number when the first screen load factor is 0˜50% and the second screen load factor is less than the first screen load factor.

6. The plasma display device of claim 5, wherein the first number and the second number are equal when the first screen load factor is 51˜100% and the second screen load factor is less than the first screen load factor or when the image signal displayed in the previous frame is determined as a moving image

7. The plasma display device of claim 5, wherein the first number is 2, and the second number is 1.

8. The plasma display device of claim 6, wherein the reset pulse is a main reset pulse comprising:
a rising ramp pulse; and
a falling ramp pulse,
wherein the main reset pulse is applied to the scan electrode in the reset period of the previous frame or the current frame.

9. The plasma display device of claim 1, further comprising:
an address electrode driver connected between the plasma display panel and the controller to apply a display data signal to an address electrode of the plurality of address electrodes according to the controller; and
a sustain electrode driver connected between the plasma display panel and the controller to apply a sustain pulse to a sustain electrode of the plurality of sustain electrodes according to the controller.

10. A driving method of a plasma display device having a plurality of scan electrodes, a plurality of sustain electrodes, and a plurality of address electrodes, the driving method comprising:
dividing one frame into a plurality of subfields having a number of emissions;
dividing each subfield into a reset period, an address period, and a sustain period;
displaying in a previous frame having a first screen load factor a still image that is continuously sustained for a duration time greater than a predetermined time;
displaying an image of a current frame having a second screen load factor, the image of the current frame being different from the still image;
determining in a controller whether the second screen load factor is less than the first screen load factor; and
controlling a first number of reset pulses applied to a scan electrode of the plurality of scan electrodes in the reset period of the current frame and a second number of reset pulses applied to the scan electrode of the plurality of scan electrodes in the reset period of the previous frame,
wherein the first number and second number are different if the second screen load factor is less than the first screen load factor.

11. The driving method of claim 10, wherein the displaying the still image of the previous frame comprises:
storing image signals by each frame in a frame memory;
comparing image signals of the previous and current frames in a still image determiner connected to the frame memory to determine whether the current frame includes a still image; and
determining the duration time of the determined still image in a timer that is connected to the still image determiner

12. The driving method of the plasma display device of claim 11, wherein the predetermined time is about 25 to 35 seconds.

13. The driving method of claim 11, wherein the determining in the controller whether the second screen load factor is less than the first screen load factor comprises:
calculating the first screen load factor and the second screen load factor in a load factor calculator connected to the still image determiner; and
comparing the first screen load factor to the second screen load factor in a dark image retention determiner connected to the load factor calculator to determine whether a dark image is retained in the current frame.

14. The driving method of claim 13, wherein the comparing of the first screen load factor to the second screen load factor comprises:
determining that the dark image is retained in the current frame if the first screen load factor is 0˜50% and the second screen load factor is less than the first screen load factor.

15. The driving method of claim 14, wherein the first number of reset pulses applied in the reset period of the current frame is larger than the second number of reset pulses applied in the reset period of the previous frame if the dark image is determined to be retained.

16. The driving method of claim 15, wherein the first number of reset pulses applied in the reset period of the current frame is equal to the second number of reset pulses applied in the reset period of the previous frame if the first screen load factor is 51˜100% and the second screen load factor is less than the first screen load factor or if the image signal displayed in the previous frame is a moving image.

17. The driving method of claim 15, wherein the first number is 2, and the second number is 1.

18. The driving method of claim 10, further comprising:
applying the first number of reset pulses to the scan electrode in the reset period of the current frame and the second number of the reset pulses to the scan electrode in the reset period of the previous frame.

19. The driving method of claim 18, wherein the reset pulse is a main reset pulse comprising:
a rising ramp pulse; and
falling ramp pulse;
wherein the main reset pulse is applied to the scan electrode in the reset period of the previous frame or the current frame.

20. The driving method of claim 10, further comprising:
applying a display data signal to an address electrode of the plurality of address electrodes from an address electrode driver that is connected to the plasma display panel; and
applying a sustain pulse to a sustain electrode of the plurality of sustain electrodes from a sustain electrode driver that is connected to the plasma display panel.
